(19) United States
(12) Patent Application Publication
(10) Pub. No.: US 2010/0169139 A1
(43) Pub. Date: Jul. 1, 2010

(54) Smart Building Unified Managed Solutions

(76) Inventor: Pamela Denise Koenig-Richardson, Grapevine, TX (US)

Correspondence Address: Pamela Koenig-Richardson, 2121 Brentcove Drive, Grapevine, TX, 76051, US

(21) Appl. No.: 12/653,050

(22) Filed: Dec. 8, 2009

Related U.S. Application Data
(60) Provisional application No. 61/201,300, filed on Dec. 10, 2008.

(51) Int. Cl. G06Q 10/00; G06Q 90/00

(52) U.S. Cl. 705/7; 705/500

(57) ABSTRACT

Smart Building Unified Managed Solutions identifies and self heals to resolve inefficient facility environmental variables defined by energy, communications, operations, security, fire, video, video transmission and building controls through a single managed business process solution allowing the facility operators to always have a single view of the entire facility maximizing security and energy savings to the facility including introduction and integration of alternate sources of energy i.e. wind, solar, nuclear.

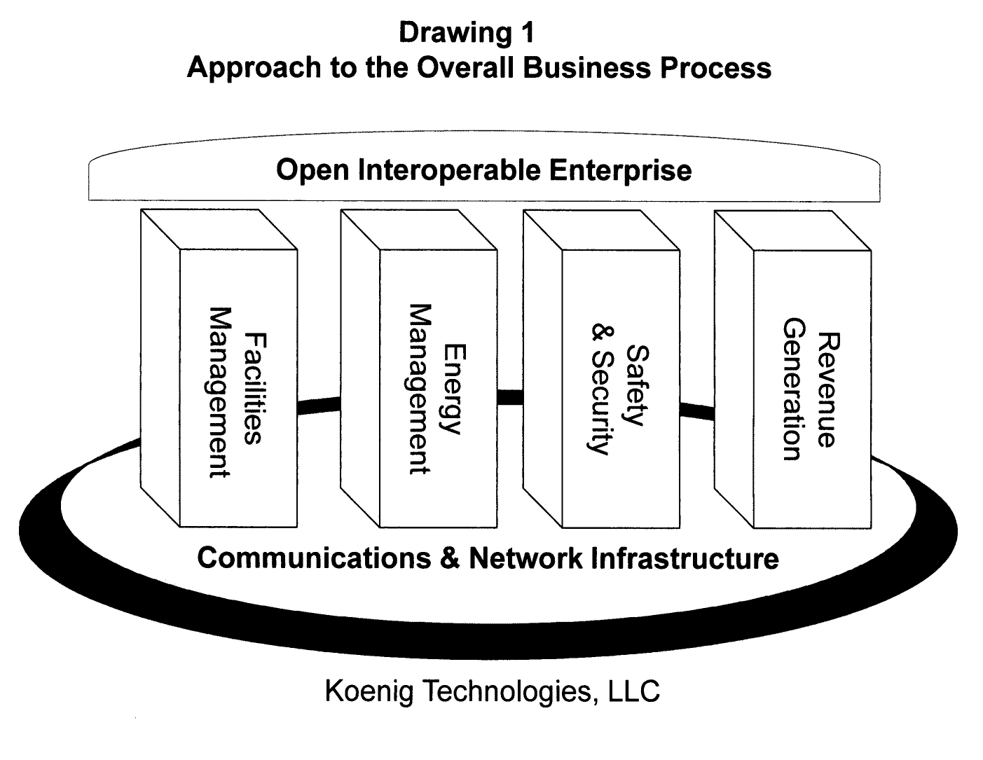

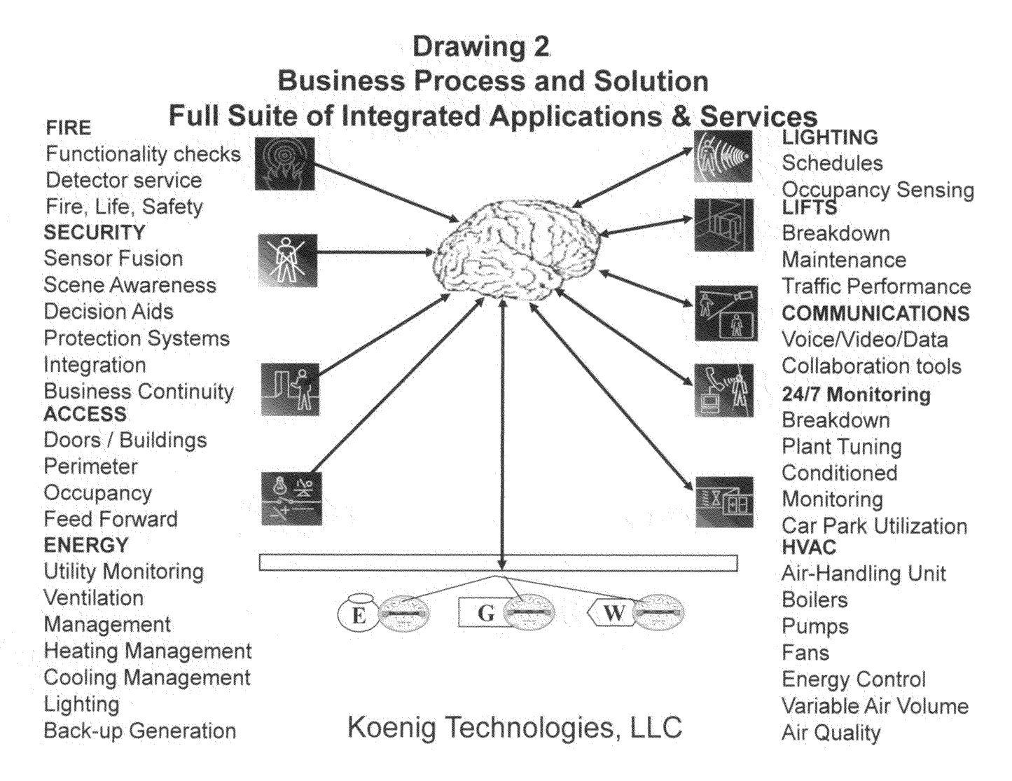

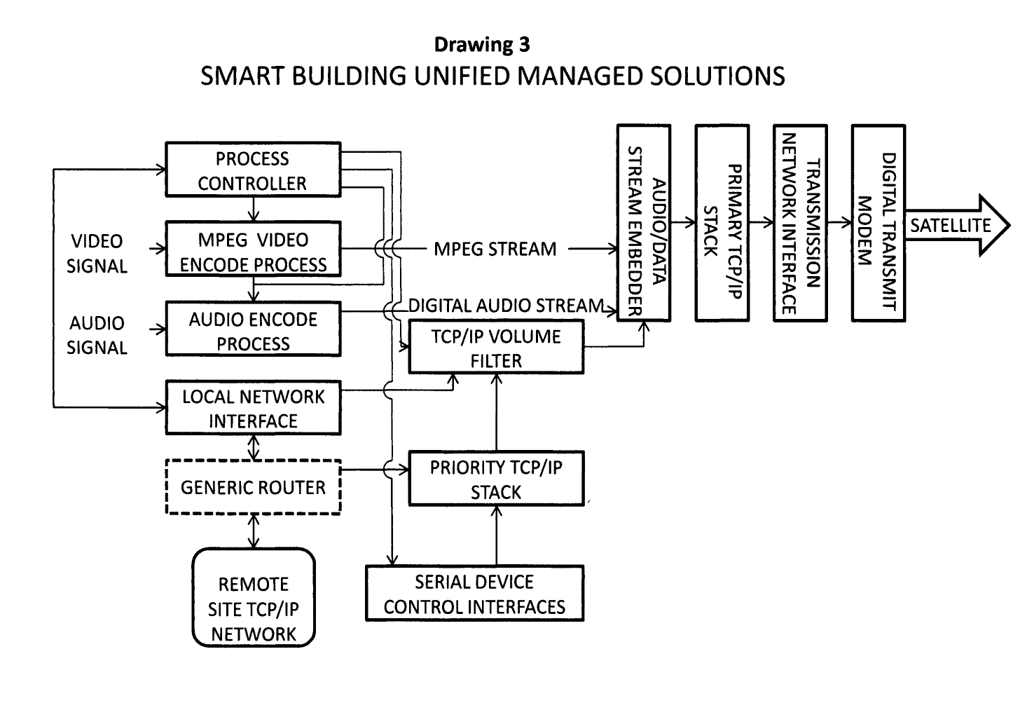

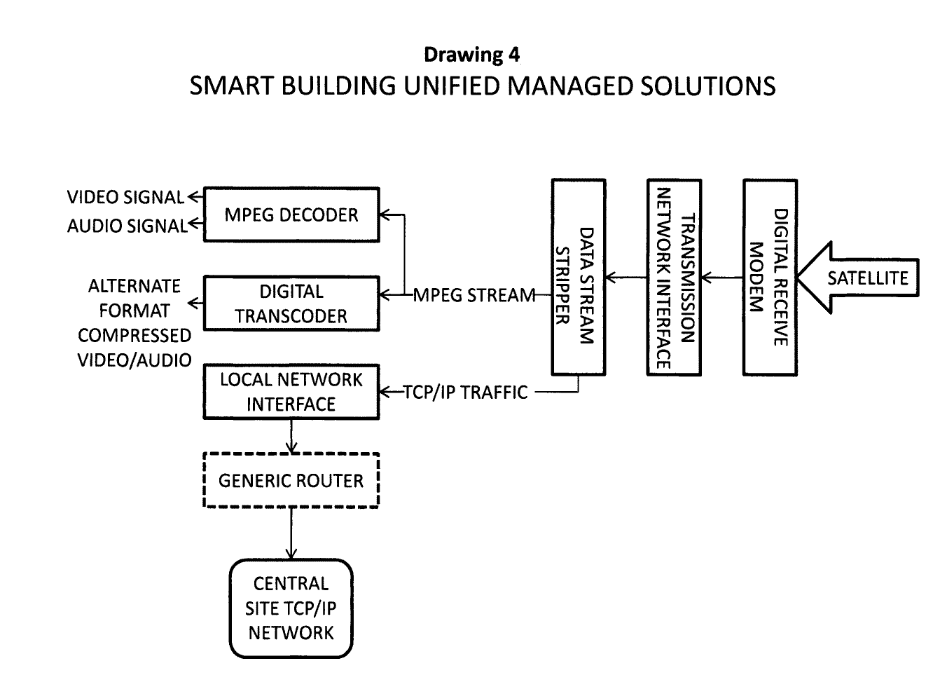

### CROSS-REFERENCE TO RELATED APPLICATIONS

Not Applicable

### STATEMENT REGARDING FEDERALLY-SPONSORED RESEARCH AND DEVELOPMENT

Not Applicable

### BACKGROUND OF THE INVENTION

Smart Building Unified Managed Solutions engages all building components, communications, power, energy, facilities, operations, security, fire, lighting, SCADA, green environments conditions, physical intrusion detection and security measures, network and infrastructure status awareness, and maintenance scheduling. The system incorporates an Information Fusion Engine as its machine/human interface to more fully expose information in human understandable format. Large facility operators are unable to manage, heal, get pre-notified of failing components, and securely maintain the complete efficiency and balance while identifying real-time threats in a single business process solution. The Smart Building Unified Managed Solution provides and enables a software neural network comprised of a community of agents that acts independently and on behalf of program authority to decide if (and which of many) actions are appropriate on the basis of self-determined heuristics for the facility operators. The Agency is not invoked for a task but is instead capable of independent action and anticipation based on continuous sensory and data analytics to control and maintain appropriately power consumption in the delivery of environmental and building services.

Specific problems this invention solves:
Maintaining all desired environmental variables of a large (or small) facility throughout the facility while utilizing the most efficient methods and processes to maintain all of the facility environmental requirements including alternate sources of energy i.e. wind, solar, nuclear.
Auto healing and recalibration of itself and the system to consistently maintain the facility environmental efficiencies
Method and Apparatus for Transmission of a Multiplicity of Digital Video Streams with a Multiplicity of Concurrent Serial and Statistical Data Channels which perform Continuous recording of actual physical conditions for analytic correction of heuristic errors (self learning) generated by an agent's interactions with its environment
Identify and isolate components nearing end of life, deteriorating components, security threats, environmental exposures, and perform self healing solutions to regain the most efficient balance of the facility environmental variables
Evaluate, record, report and analyze all environmental conditions where by the recalibration and auto and self healing solutions are then applied to balance and bring harmony to all facility environmental variables. This constant evaluation recording and analysis allows new variables to be introduced efficiently and integrated into the process enabling auto efficiencies and self healing immediately upon introducing them into the facility environment

The inventor has designed the business process as well as the technical solution components including a software neural network comprised of a community of agents and sensory components required to achieve a Smart Building Unified Managed Solution to fully engage all of the building components (communications, power, energy, facilities, operations, security, fire, lighting, SCADA, green environments conditions, physical intrusion detection and security measures, network and infrastructure status awareness, and maintenance scheduling) to maximize efficiencies, reduce failures, lower operational and environmental costs of ownership, improve workers quality of environment, provide safer facilities for environment and enable one single management solution to manage, analyze, maintain, report, and heal all of these facility areas including communications, security, operations, building controls, fire and energy. The facility operator will no longer need invest in multiple management platforms, purchase and maintain multiple management licenses and enable himself completed control to set environmental variables which the Smart Building Unified Managed Solutions will then carry out.

### BRIEF SUMMARY OF THE INVENTION

Today facility operators account for the world's largest consumption of energy as well as they bear wasteful and cumbersome costs of managing the facility. An example is the facility may have Alcatel phones which requires Alcatel phone licenses, and management platform; a Cisco routed infrastructure which also costs them a great deal of money to manage since they need a Cisco management solution with additional licenses; if Siemens is providing the building controls for security the facility will incur the same burden of costs for the management and licenses of the security system, now multiply this same costs structure by every application, device, sensor, camera, conference, lighting, elevator, escalator, water fountain, etc and you have a cost and management nightmare. Pamela Denise Richardson-Koenig addresses and resolves this issue by building the facility operators a single managed solution which communicates with all open standards based devices such as Cisco, Alcatel, Siemens, Honeywell, IBM, Microsoft, Oracle and SAP to name a few of the largest. This allows the facility operators to always have a single view of the entire facility which allows them to also operate the facility utilizing common knowledge and competencies which further provides security and efficiencies to the facility. We have included a drawing of the mart building process solution as well.

### BRIEF DESCRIPTION OF THE SEVERAL VIEWS OF THE DRAWINGS

The drawings included are as follows:

Drawing 1: Smart Building Unified Managed Solutions approach to the overall business process for managing a unified facility

Drawing 2: Smart Building Unified Managed Solutions. A drawing representation of the business process and solution we are patenting showing the Facility “Brain” which is a software neural network comprised of a community of agents that acts independently and on behalf of program authority to decide if (and which of many) actions are appropriate on the basis of self-determined heuristics for the facility operators. The Agency is not invoked for a task but is instead capable of independent action and anticipation based on continuous sensory and data analytics to control and maintain appropriately power consumption in the delivery of environmental and building services. This represents the brain controlling and maintaining all aspects of the facility.

Drawing 3—Device A: A computerized digital video encoder/compressor consisting of the following sub-components:
A-01 Process Controller
A-02 MPEG Video Encoder Process
A-03 Audio Encode Process
A-04 Local Network Interface
A-05 TCP/IP Volume Filter
A-06 Priority TCP/IP Stack
A-07 Serial Device Control Interface
A-08 Audio/Data Stream Embedder
A-09 Primary TCP/IP Stack
A-10 Transmission Network Interface

Drawing 4—Device B: A computerized digital video decompressor/decoder and/or transcoder consisting of the following sub-components:
B-01 MPEG Decoder
B-02 Digital Transcoder (Optional)
B-03 Local Network Interface
B-04 Data Stream Stripper
B-05 Transmission Network Interface

### DETAILED DESCRIPTION OF THE INVENTION

A software neural network comprised of a community of agents that acts independently and on behalf of program authority to decide if (and which of many) actions are appropriate on the basis of self-determined heuristics. The Agency is not invoked for a task but is instead capable of independent action and anticipation based on continuous sensory and data analytics to control and moderation power consumption in the delivery of environmental and building services, energy consumption and efficiencies, lighting, SCADA, communications, Power, operations, facilities, fire, video, green environmental conditions, physical intrusion detection and security measures, network and infrastructure status awareness, and maintenance scheduling. The system incorporates an Information Fusion Engine as its machine/human interface to more fully expose information in human understandable format.

Considerations:
Seasonal and daily thermal load characteristics required to maintain uniformity of environmental conditions in occupied spaces;
Anticipation of room environmental control activation by means of analysis of existing community schedules and behaviors;
Actuation and deactivation of lighting, data appliances, and additional support infrastructure as determined by direct real-time machine sensory observation of actual temperature, lighting, and physical occupation;
Behavior analytics for entire systems with additional behavior analytics for energy modeling tool to determine optimal energy efficiencies and automatically perform modifications to the system to achieve the optimal energy consumption

### Self-determined Policy Bias and Challenge Validation

Continuous recording of actual physical conditions for analytic correction of heuristic errors (self learning) generated by an agent's interactions with its environment. At predetermined intervals the Agency performs an action and the environment generates an observable condition with an instant cost in accordance with an unknown dynamic. The agent interacts with its control infrastructure to discover and validate policies for selecting actions that minimizes some measure of a long-term cost, i.e. the lowest expected cumulative cost. The process continues over time until equilibrium is firmly established, and thereafter occasionally challenges its own policies to validate continuing assumptions. While environmental dynamics may be subject to change over time (seasonal variation), short interval changes (rooms not always occupied), and the long-term cost for each policy are unknown at inception, the Agency learns from its actions to construct, refine, and challenge policies (heuristics) to deliver the most optimal result regardless of building configuration or reconfiguration, human behavior, and seasonal variations.

1: Maintaining all desired environmental variables of a large (or small) facility throughout the facility while utilizing the most efficient methods and processes to maintain all of the facility environmental requirements including alternate sources of energy i.e. wind, solar, nuclear.

2: Seasonal and daily thermal load characteristics required to maintain uniformity of environmental conditions in occupied spaces

3: Behavior analytics for entire systems with additional behavior analytics for energy modeling tool to determine optimal energy efficiencies and automatically perform modifications to the system to achieve the optimal energy consumption

4: Actuation and deactivation of lighting, data appliances, and additional support infrastructure as determined by direct real-time machine sensory observation of actual temperature, lighting, and physical occupation;

5: Anticipation of room environmental control activation by means of analysis of existing community schedules and behaviors;

6: Evaluate, record, report and analyze all environmental conditions where by the recalibration and auto and self healing solutions are then applied to balance and bring harmony to all facility environmental variables. This constant evaluation recording and analysis allows new variables to be introduced efficiently and integrated into the process enabling auto efficiencies and self healing immediately upon introducing them into the facility environment

7: The Method and Apparatus may be applied whenever any multi-layer serial data stream is used as a carrier of extraneous data traffic to eliminate packet collision and discards from multiple unpredictable devices or traffic sources.

8: Method and Apparatus for Transmission of a Multiplicity of Digital Video Streams with a Multiplicity of Concurrent Serial and Statistical Data Channels which perform Continuous recording of actual physical conditions for analytic correction of heuristic errors (self learning) generated by an agent's interactions with its environment

9: Auto healing and recalibration of itself and the system to consistently maintain the facility environmental efficiencies

10: Identify and isolate components nearing end of life, deteriorating components, security threats, environmental exposures, and perform self healing solutions to regain the most efficient balance of the facility environmental variables
